(19) United States
(12) Patent Application Publication
(10) Pub. No.: US 2026/0044663 A1
(43) Pub. Date: Feb. 12, 2026

(54) PATTERN CLUSTERING METHOD, SIMULATION METHOD USING THE SAME, AND SYSTEM

(71) Applicant: SAMSUNG ELECTRONICS CO., LTD., Suwon-si (KR)

(72) Inventors: Jihye Lee, Suwon-si (KR); Satbyul Kim, Suwon-si (KR); Hyunjae Jang, Suwon-si (KR); Seongryeol Kim, Suwon-si (KR); Younggu Kim, Suwon-si (KR)

(21) Appl. No.: 19/222,940

(22) Filed: May 29, 2025

(30) Foreign Application Priority Data
Aug. 9, 2024 (KR) 10-2024-0107079

(51) Int. Cl. G06F 30/398

(52) U.S. Cl. CPC G06F 30/398

(57) ABSTRACT

Provided is a method of evaluating an integrated circuit. The method includes obtaining a plurality of patterns representing a layout of the integrated circuit; clustering the plurality of patterns into a plurality of clusters based on geometric features of the plurality of patterns, and simulation results obtained by simulating properties of the plurality of patterns; selecting a representative pattern of each of at least one cluster of the plurality of clusters; and verifying the representative pattern of each of at least one cluster and evaluating performance of the integrated circuit based on this.

### CROSS-REFERENCE TO RELATED APPLICATION

This application claims priority under 35 U.S.C. § 119 to Korean Patent Application No. 10-2024-0107079, filed on Aug. 9, 2024, in the Korean Intellectual Property Office, the entirety of which is incorporated by reference herein.

### BACKGROUND

Analyzing and verifying patterns included in an integrated circuit in advance may shorten the development period and improve the reliability of the integrated circuit. As semiconductor processes develop, integrated circuits may include a myriad of patterns, and the types of patterns may also be remarkably diverse. Accordingly, it may be practically challenging to analyze or verify all of the patterns included in integrated circuits, and a method of efficiently and accurately verifying the patterns may be beneficial.

### SUMMARY

According to conventional methods, the actual physical properties or defective characteristics of patterns may not be reflected by clustering patterns using only geometric features included in the patterns, resulting in poor accuracy.

Some implementations according to the present disclosure provide a method of systematically verifying an integrated circuit by generating clustering reflecting the physical properties and defect possibilities of patterns and extracting a representative pattern based on the generated clustering.

According to some implementations of the present disclosure, there is provided a method of evaluating an integrated circuit. The method may include obtaining a plurality of patterns representing a layout of the integrated circuit; clustering the plurality of patterns into a plurality of clusters based on geometric features of the plurality of patterns, and simulation results obtained by simulating properties of the plurality of patterns; selecting a representative pattern of each of at least one cluster of the plurality of clusters; and verifying the representative pattern of each of at least one cluster and evaluating performance of the integrated circuit based on this.

According to some implementations of the present disclosure, there is provided a method of simulating an integrated circuit. The simulation method may include performing first clustering, in a latent space, of a plurality of pattern images of layout patterns of the integrated circuit; updating the first clustering by performing a feedback process on clustering results at least once, to obtain an N-th clustering corresponding to a plurality of clusters; selecting a representative pattern of each of at least one cluster of the plurality of clusters; and performing a simulation of the integrated circuit based on the representative pattern of each of the at least one cluster.

According to some implementations of the present disclosure, there is provided a system. The system may include at least one processor; and a non-transitory storage medium storing instructions that, when executed by the at least one processor, cause the at least one processor to perform operations comprising: obtaining a plurality of patterns representing a layout of an integrated circuit; clustering the plurality of patterns into a plurality of clusters based on geometric features of the plurality of patterns, and simulation results obtained by simulating properties of the plurality of patterns; selecting a representative pattern of each of at least one cluster of the plurality of clusters; and verifying the representative pattern of each of at least one cluster and evaluating performance of the integrated circuit based on this.

The clustering the plurality of patterns comprises: obtaining a first clustering result based on the geometric features, and modifying the first clustering result to obtain a second clustering result by a feedback process based on the simulation results using a pairwise constraint.

The clustering the plurality of patterns comprises performing data sampling such that an imbalance in similarities of the plurality of patterns is compensated for.

The selecting the representative pattern of each of the at least one cluster of the plurality of clusters is based on a distance in a latent space in which the plurality of patterns are clustered, or probabilities of the plurality of patterns.

The verifying the representative pattern of each of the at least one cluster based on a distance measure of the representative pattern in a latent space in which the plurality of patterns are clustered.

The verifying the representative pattern of each of the at least one cluster based on a similarity between geometric features of the representative pattern and geometric features of at least one other pattern of the plurality of patterns.

The verifying the representative pattern of each of the at least one cluster based on a similarity between a simulation result of the representative pattern and a simulation result of at least one other pattern in a cluster including the representative pattern.

### BRIEF DESCRIPTION OF THE DRAWINGS

The foregoing and other implementations will be more clearly understood from the following detailed description taken in conjunction with the accompanying drawings in which:

FIG. 1 is a block diagram illustrating an example of a pattern clustering system;

FIG. 2 is a diagram illustrating an example of a pattern clustering operation;

FIG. 3 is a flowchart illustrating an example of a pattern clustering method;

FIG. 4 is a diagram illustrating examples of operations performed in a clustering generator and a clustering analyzer;

FIG. 5A illustrates examples of comparative layout diagrams;

FIG. 5B is a table illustrating an example of accuracy of a bad cluster according to output at each stage of clustering;

FIGS. 6A to 6F are diagrams illustrating examples of outputs in stages of clustering;

FIG. 7A is a diagram illustrating an example of a distribution of a latent space;

FIG. 7B is a diagram illustrating an example of data sampling;

FIG. 7C is a diagram illustrating data sampling as a comparative example;

FIG. 8 is a diagram illustrating an example of balanced sampling;

FIGS. 9A and 9B are diagrams illustrating an example of a method of selecting a representative pattern;

FIGS. 10A to 10D are diagrams illustrating examples of methods of evaluating the performance of a representative pattern;

FIG. 11 is a block diagram illustrating an example of pattern clustering;

FIG. 12 is a block diagram illustrating an example of a computer system; and

FIG. 13 is a block diagram illustrating an example of a system.

### DETAILED DESCRIPTION

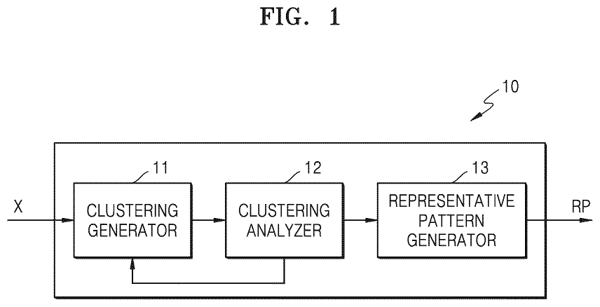

FIG. 1 is a block diagram illustrating a pattern clustering system 10. The pattern clustering system 10 may generate clusters of latent variables, e.g., clusters of patterns, by generating a latent variable corresponding to a pattern from input data representing the pattern and grouping a plurality of latent variables corresponding to a plurality of patterns. Patterns included in one cluster (or group) may have at least one attribute that is the same or similar, and accordingly, clusters of patterns are analyzed (e.g., instead of all patterns included in an integrated circuit), so that the integrated circuit may be efficiently analyzed and verified. In the present specification, a pattern may refer to a part of a layout of an integrated circuit, the pattern including at least one structure formed on at least one layer. In the present specification, the pattern may be interchangeably referred to as a pattern image.

As shown in FIG. 1, the pattern clustering system 10 may include a clustering generator 11, a clustering analyzer 12, and a representative pattern generator 13.

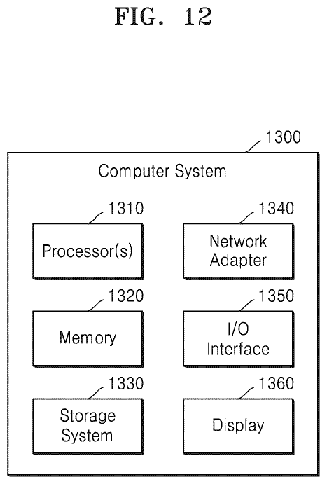

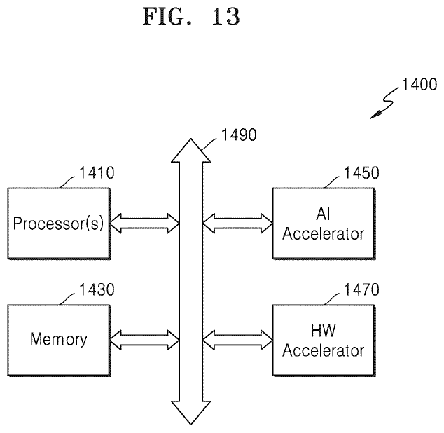

In some implementations, the pattern clustering system 10 of FIG. 1 is implemented as a computing system described below with reference to FIGS. 12 and 13. For example, each of the blocks shown in the drawings of the present specification may correspond to hardware, software, or a combination of hardware and software included in the computing system. In some implementations, the hardware includes at least one of a programmable component, such as a central processing unit (CPU), a digital signal processor (DSP), a graphics processing unit (GPU), a reconfigurable component, such as a field programmable gate array (FPGA), and/or a component providing fixed functionality, such as an intellectual property (IP) block. In some implementations, the software includes at least one of a series of instructions executable by a programmable component and a code convertible into a series of instructions by a compiler or the like, and may be stored in a non-transitory storage medium.

As semiconductor processes develop, it may be practically challenging to completely analyze patterns of an integrated circuit having a high degree of integration. Accordingly, the integrated circuit may be analyzed based on attributes that cluster (or group) patterns included in the integrated circuit, attributes that distinguish clusters (or groups), and/or distributions or tendencies of attributes detected in patterns included in one cluster. For clustering of patterns, a distance or similarity between patterns may be defined, and patterns having a short distance or high similarity may be included in one cluster. That is, patterns corresponding to latent variables close to each other in a latent space may have similar properties. As described below with reference to the drawings, the pattern clustering system 10 may map one pattern to one point of a latent space (or a representation space), e.g., one latent variable, and may group patterns having a lower Euclidean distance in a latent space into one cluster. Accordingly, patterns included in the integrated circuit may be effectively clustered, and each of the clusters may have its own properties.

In addition to the geometric features of the pattern, the pattern clustering system 10 may perform clustering by considering defects in the pattern, features of physical properties, simulation results according to the pattern, and/or the like. In addition, or alternatively, data may be sampled to secure the diversity of the clusters grouped through the pattern clustering system 10 and to solve the imbalance of the data, and accordingly, clustering trained through various patterns may be secured by feeding back a simulation result of the selected data. Accordingly, representative patterns of the plurality of derived clusters are extracted and performance of the representative patterns are evaluated, and thus, representative patterns of a layout included in a full-chip may be extracted and accordingly, the integrated circuit may be efficiently verified.

Referring to FIG. 1, input data used to derive a latent variable may be a pattern image X. The pattern image may represent a region that includes a pattern in a layout of an integrated circuit, and may be simply referred to herein as a pattern. For example, at least one layer requiring an analysis may be extracted from data defining the layout of an integrated circuit, and pattern images may be obtained by dividing the extracted at least one layer according to a window of a predefined size. Accordingly, the pattern image may include two-dimensional (2D) geometric information. In some implementations, when the pattern includes structures formed on a plurality of layers, the pattern image may include a plurality of 2D arrays, and each of the 2D arrays may correspond to one layer. For example, when a two-dimensional array includes 50×50 pixels, the pattern image may have a size of 50×50×(a number of layers).

As shown in FIG. 1, the clustering generator 11 may receive a plurality of pattern images X and perform first pattern clustering based on the received pattern images X. According to an example, the clustering generator 11 may include a machine learning model trained by a plurality of sample images and a plurality of sample values, for example, a deep neural network. In some implementations, the clustering generator 11 includes mutually independent models. For example, the clustering generator 11 may include a model trained to receive a pattern image X and output a latent variable and a model trained to receive the feedback result output from the clustering analyzer 12 to update the latent variable. A detailed method of operating the clustering generator 11 is described below.

In the present specification, a machine learning model may have any structure capable of training with sample data or training data. For example, the machine learning model may include an artificial neural network, a decision tree, a support vector machine, a Bayesian network, and/or a genetic algorithm. Hereinafter, the machine learning model will be mainly described with reference to an artificial neural network, but it is noted that implementations of the present disclosure are not limited thereto. The artificial neural network may include, but is not limited to, a convolution neural network (CNN), a region efficient convolution neural network (R-CNN), a region proposal network (RPN), a recurrent neural network (RNN), stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and the like. In the present specification, the machine learning model may be simply referred to as a model.

According to an example, the clustering analyzer 12 may output data for feeding back the clustering result output from the clustering generator 11 to the clustering generator 11. The clustering analyzer 12 may further include a simulator capable of simulating a pattern image corresponding to a latent variable. According to an example, the clustering analyzer 12 may perform a defect prediction simulation of a pattern image, a physical property test simulation of a pattern image, and/or the like. According to an example, the clustering analyzer 12 may execute an algorithm capable of selecting a pattern to be simulated among pattern images corresponding to the latent variable, and may execute an algorithm capable of processing data sampling to process an imbalance of the result. According to an example, the pattern may have various attributes that are not expressed as a two-dimensional image, and the clustering analyzer 12 may perform feedback by transmitting data of these attributes to the clustering generator 11. According to an example, the data transmitted to the clustering generator 11 by the clustering analyzer 12 may be information on a material constituting the pattern image, whether the pattern image is defective, a simulation/inspection result of the pattern image, and/or the like. A detailed method of operating the clustering analyzer 12 will be described below.

The representative pattern generator 13 may receive final clustering of a plurality of latent variables output from the clustering analyzer 12, and may select a representative pattern of each of the plurality of clusters based on the received final clustering. The representative pattern generator 13 may evaluate whether the representative pattern in each cluster is appropriately selected. Accordingly, when the representative pattern is appropriate, is suitable, satisfies a criterion, and/or the like, representative patterns RP of each cluster may be output. Therefore, the pattern clustering system 10 may receive the pattern images X of an integrated circuit, perform clustering according to a series of conditions, select and evaluate a representative pattern of each cluster, and output the selected and evaluated representative pattern, and perform a simulation of the integrated circuit based on the representative pattern RP.

According to some implementations of the present disclosure, significant geometric features may be identified and classified in the results of simulation and inspection, by including an operation of reflecting, or accounting for, simulation and/or inspection data in a series of processes of classifying pattern images of a layout image. Accordingly, the representative pattern may be optimized, and simulation of the plurality of pattern images included in the layout image may be more efficiently and/or effectively performed.

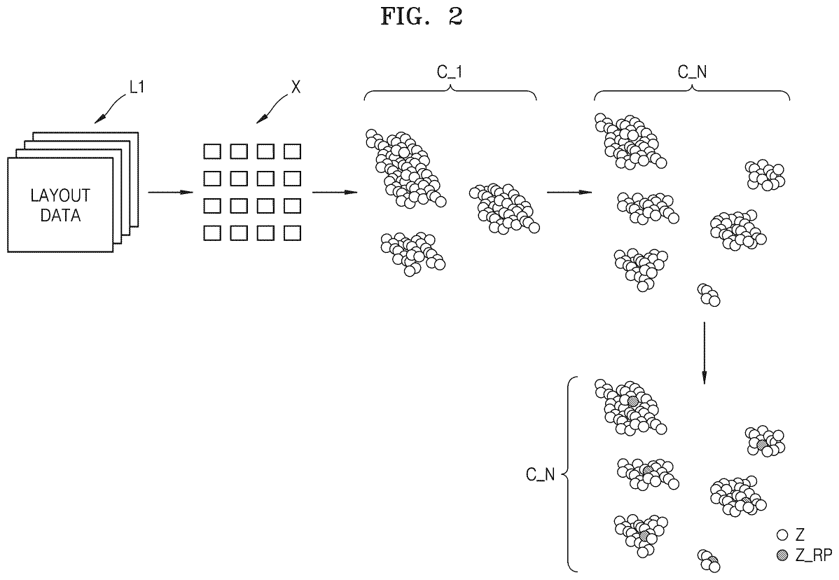

FIG. 2 is a diagram illustrating an operation of pattern clustering. Referring to FIG. 2, a plurality of pieces of layout data L1 are illustrated. The plurality of pieces of layout data L1 may be layout data of an integrated circuit for which a simulation is to be finally performed. According to an example, the number of a plurality of pattern images included in the layout data of the integrated circuit may be hundreds to hundreds of millions. Since it may be challenging (e.g., practically impossible) to simulate all of these, clustering may be performed using the pattern images X obtained by dividing the layout data into a predetermined size. According to an example of FIG. 2, there are 16 pattern images X, but only a few are shown for convenience of explanation, and the number of pattern images X to be clustered may be much higher. According to an example, the layout data L1 may be provided as data in a graphic design system (GDS) format, and information of all polygons may be displayed in coordinates. According to another example, the layout data L1 may be provided as data in an open artwork system interchange standard (OASIS) file and/or other design layout file format. The layout data L1 according to an example may not be limited to an image, but may include vector or netlist data indicating GDS data in coordinates.

The pattern images X are input to the clustering generator 11 of FIG. 1 and may be converted into a latent variable in a latent space, and first clustering C_1 in which the pattern images X are first-clustered is initiated. Points (i.e., small circles) included in the first clustering C_1 may mean latent variables Z corresponding to each of the pattern images X. The first clustering C_1 according to an example may include three clusters, and each of the three clusters may include at least one pattern. According to an example, the first clustering C_1 may be a clustering result formed by learning the geometric patterns of the pattern images X. According to an example, the first clustering C_1 may be a first output of the clustering generator 11. According to an example, when a result of a simulation or inspection of patterns included in the first clustering C_1 is checked, similar patterns may have different physical properties or defective possibilities, or conversely, different patterns may have similar physical properties or defective possibilities. This means that in order to classify patterns in connection with actual physical properties and defects, the model should be trained so that the latent space is meaningful not only for geometric features but also for physical properties/defect possibilities.

In the present disclosure, features of patterns other than the geometric patterns may be additionally trained to generate N-th clustering C_N. In this case, N may be a natural number greater than or equal to 2. According to an example, additional learning may be performed by updating physical features of patterns other than the geometric patterns into the first clustering C_1, and the final N-th clustering C_N may be generated by repeating this N times. Referring to the N-th clustering C_N, it may be seen that the number of clusters is further increased and the size of the cluster is also reduced compared to the first clustering C_1. According to an example, since the pattern image is clustered by various conditions and sampling in the N-th clustering C_N, a more detailed clustering result may be derived.

When the final N-th clustering C_N is output, a representative pattern of clusters included in each of the N-th clustering C_N may be selected. According to an example, the N-th clustering C_N may include six clusters, and accordingly, latent variables corresponding to the six representative patterns Z_RP may be selected as representative patterns. The representative patterns Z_RP may be verified with respect to whether to represent each cluster.

According to some implementations of the present disclosure, a representative pattern selection and evaluation methodology for representing the entire integrated circuit is provided. The classification of layout patterns may be a tool to systematically verify the design robustness of the entire circuit, and may be introduced into various processes of design from initial design option search to manufacturing feasibility guarantee and yield optimization. AI-based layout pattern classification may effectively quickly recognize and classify the geometric features of vast patterns in an entire circuit. In order to select representative patterns and vulnerable patterns by linking the recognized and classified geometric features to actual physical properties and defects, an extended technology that may identify and classify significant geometric features in simulation and inspection results may be provided.

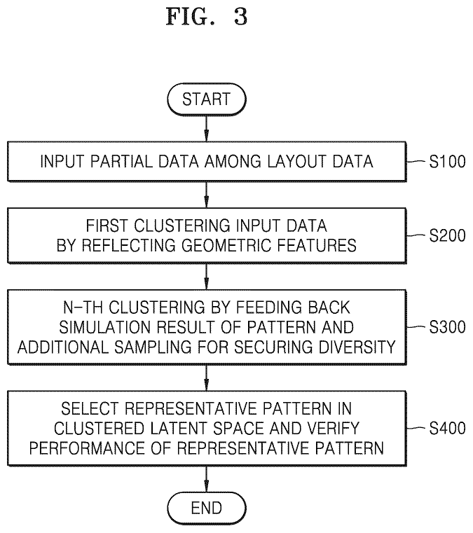

FIG. 3 is a flowchart illustrating a pattern clustering method. Referring to operation S100 of FIG. 3, some of the layout data may be input to the clustering generator. According to an example, the layout data may include a plurality of pattern images. The layout data may include a plurality of pattern images corresponding to a portion of a layout included in an integrated circuit. Some of the plurality of pattern images may be input to the clustering generator 11 of FIG. 1.

Referring to operation S200 of FIG. 3, first clustering may be performed based on a pattern input to the clustering generator 11. According to an example, operation S200 may be performed in a space converted into a low-dimensional latent variable. First clustering may be performed based on the geometric features of the pattern image.

Referring to operation S300 of FIG. 3, in the clustering analyzer 12, N-th clustering may be performed by feeding back the simulation result of the pattern and additional sampling for securing diversity. In this case, N may be a natural number greater than or equal to 2. In operation S300, the first clustering generated in operation S200 may be fed back and corrected by reflecting the simulation result of the pattern, and the result of considering whether the pattern is defective, physical properties, and/or the like. By repeating these processes, clustering may be performance by reflecting, or accounting for, not only the geometric features of the pattern image but also the simulation according to the pattern (e.g., results of simulating the pattern). In operation S300, in order to secure diversity of the simulation data, the simulation data may be selected by reflecting additional sampling, and clustering may be fed back based on the selected data. In addition, when there are a large number of similar patterns of clustered data, unbalanced derived clustering may be corrected through balanced sampling. By repeating such a process, the final N-th clustering may be derived.

Referring to operation S400 of FIG. 3, a representative pattern may be selected from the clustered latent space, and performance verification of the representative pattern may be performed. According to an example, the representative pattern generator may receive a final N-th clustered model and select a representative pattern in each clustering group based on the received model. In order to check whether the selected representative patterns are appropriately selected, the performance of the representative pattern may be evaluated using various methods. When it is determined that the performance of the representative pattern satisfies a predetermined condition, simulation of the integrated circuit may be performed using the corresponding pattern as the representative pattern.

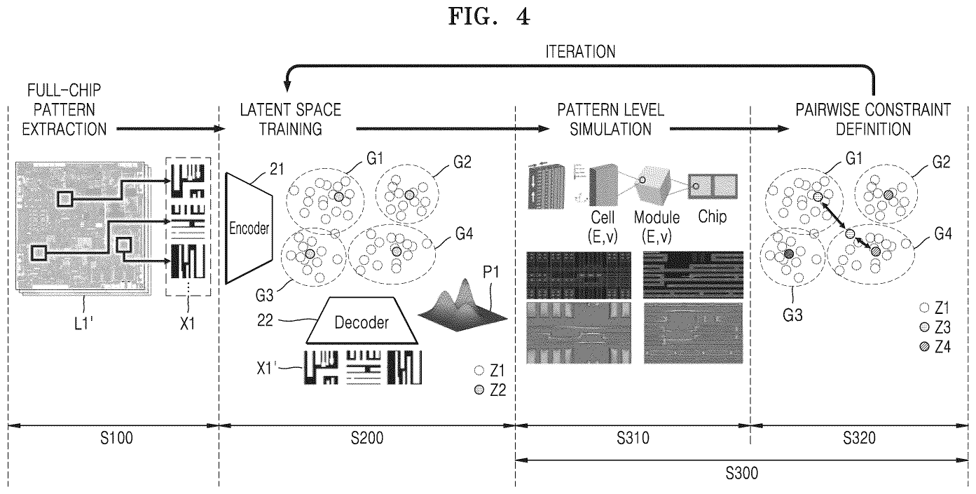

FIG. 4 is a diagram illustrating some operations in a clustering generator and a clustering analyzer. Referring to FIG. 4, a diagram for describing operations corresponding to operations S100, S200, and S300 of FIG. 3 is illustrated.

Referring to operation S100 of FIG. 4, a part of a full-chip pattern layout L1′ to be simulated may be extracted as pattern images X1. According to an example, the full-chip pattern to be simulated may be an integrated circuit, and the integrated circuit may include a plurality of layers. According to an example, the layout L1′ of FIG. 4 may correspond to the layout data L1 of FIG. 2, and the pattern images X1 of FIG. 4 may correspond to the pattern images X of FIG. 2.

Referring to operation S200 of FIG. 4, a plurality of pattern images X1 may be input to an encoder 21. The encoder 21 may refer to a model for compressing, that is, encoding, high-dimensional data X1 into low-dimensional latent variables Z1 and Z2. The decoder 22 may refer to a model for restoring, that is, decoding, the low-dimensional latent variables Z1 and Z2 to high-dimensional data X1′. The encoder 21 and the decoder 22 according to an example may be variational auto-encoders (VAE). When the encoder 21 and the decoder 22 successfully compress and restore all given high-dimensional data (X1=X1′), the latent space of the latent variable may be evaluated as representing high-dimensional data well without loss. In addition, the Euclidean distance in the latent space may be used as a metric. According to another example, the pattern clustering of FIG. 4 may use an arbitrary model capable of forming a latent space. For example, pattern clustering may use models based on deep learning such as VAE, generative advertising network (GAN), and simple framework for contrast learning of visual representation (SimCLR), as well as models such as t-distributed stochastic neighbor embedding (t-sne), self-organizing maps, and principal component analysis (PCA).

According to an example, each of the latent variables formed in the latent space may correspond to one point in the latent space and may have values corresponding to the attributes of the patterns defined by the pattern image. For example, the latent variables Z1 and Z2 may have values corresponding to the shapes, patterns, and areas of the structures included in the patterns. As described above, latent variables corresponding to patterns having similar attributes may have similar values and may be located close to each other in a latent space.

Referring back to S200 of FIG. 4, the plurality of latent variables Z1 and Z2 in the latent space may be clustered among latent variables having similar geometric features. It may be seen that the plurality of latent variables Z1 and Z2 in the latent space are clustered into a first group G1, a second group G2, a third group G3, and a fourth group G4. Each of the first group G1, the second group G2, the third group G3, and the fourth group G4 may be clustered based on the geometric features of the patterns. In this case, the model of the latent variable may be trained to follow a Gaussian mixture model (GMM). Accordingly, it is possible to train (P1) to follow the Gaussian distribution for each of the clustered groups G1, G2, G3, and G4. Accordingly, by having a Gaussian distribution for each group, a latent space suitable for clustering may be formed. The model based on learning the latent space may not be limited to the Gaussian mixture model, and other models that may form a space suitable for clustering may be used. According to an example, the latent space may be designed as vector quantized variational autoencoder (VQ-VAE) assumed as a discrete probability distribution or deep embedded clustering (DEC) applying t-sne.

Based on operation S200, a latent space for clustering including latent variables was formed. The latent variables included in the currently formed latent space may be results for which only the geometric features of the pattern are trained and clustered.

Operations S310 and S320 included in operation S300 of FIG. 4 may be operations for supplementing the first clustering generated in S200 by reflecting other features of the pattern.

In operation S310, a simulation at the pattern level may be performed. According to an example, various simulations using a pattern image may be performed. According to an example, a defect prediction simulation of a pattern image, a normal operation simulation of a pattern image, an electrical inspection simulation according to a pattern image, and/or a physical property inspection simulation of a pattern image may be performed, but the simulation(s) are not limited thereto, and various simulations may be performed to check pattern physical properties and defects of the pattern.

In operation S320, learning may be performed using pairwise constraints according to the simulation result in operation S310. By performing learning with pairwise constraints, latent variables reflecting important pattern features in pattern physical properties and defective characteristics may be obtained. In the pairwise constraints, when the physical properties/the possibility of defects in the two patterns are similar, it may be defined as a positive number, but when both are different, it may be defined as a negative number, and if there is no simulation/inspection result and thus the physical properties/the possibility of defects in the two patterns are unknown, it may be defined as 0. This may be expressed as the following mathematical formula.

$${W}_{i j} = \{ \begin{matrix}> 0 similar stress \\ = 0 unknown stress \\ < 0 different stress\end{matrix}$$

In the mathematical formula, Wᵢⱼ is a value representing the similarity between the i-th latent variable and the j-th latent variable, and if this value exceeds 0, it may be determined that the physical properties/possibilities of defects of the i-th latent variable and the j-th latent variable are similar, if this value is 0, it may be determined that there is no simulation data of at least one of the i-th latent variable and the j-th latent variable, and if this value is less than 0, it may be determined that the physical properties/possibilities of defects of the i-th latent variable and the j-th latent variable are different. In this case, i and j are natural numbers of 1 or more. According to an example, training may be performed such that latent variables with Wᵢⱼ values greater than 0 may be included in the same cluster, and latent variables with Wᵢⱼ values less than 0 may be included in different clusters.

According to an example, the output in operation S310 may be an output of a latent variable corresponding to a pattern image including geometric pattern information and a simulation result. In operation S320, training may be performed such that, by comparing and learning the output result in operation S310, latent variables including similar simulation results may be clustered to update the first clustering.

According to an example, the simulation value of the first latent variable Z3 included in the first group G1 may be a value in a low-stress range, and the simulation value of the first latent variable Z3 included in the fourth group G4 may also be a value in a low-stress range. The simulation result of the first latent variable Z3 included in the first group G1 may be similar to the simulation result of the first latent variable Z3 included in the fourth group G4.

According to an example, a simulation value of the second latent variable Z4 included in the second group G2 may be a value in a high-stress range, and a simulation value of the second latent variable ZA included in the fourth group G4 may also be a value in a high-stress range. The simulation result of the second latent variable Z4 included in the second group G2 may be similar to the simulation result of the second latent variable Z4 included in the fourth group G4.

Referring to the simulation result, the first latent variables Z3 and the second latent variables ZA having similar simulation results may learn a pairwise constraint value equal to or greater than 0. Since the first latent variables Z3 and the second latent variables Z4 are included in different groups at this stage, the clustering of the latent space may be modified to supplement the case in which the different latent variables are included in different groups by feeding back the corresponding feature so that each of the first latent variables Z3 and the second latent variables Z4 is included in the same cluster.

By repeatedly performing or iterating operations S200, S310, and S320 in this way, clustering of latent variables in the latent space may be efficiently performed by reflecting (or accounting for) the geometric features of the pattern image and the simulation results. According to an example, such iteration may be repeatedly performed until a condition set therein is satisfied. According to an example, the iteration may be repeatedly performed until a predetermined number of repetitions is satisfied. According to another example, the iteration may be repeatedly performed until the number of clusters included in the clustering exceeds a predetermined number.

According to another example, as a method of reflecting similar physical properties/defects, the pairwise constraint may not be used. According to an example, when learning is performed in a latent space, pattern images and physical properties/defects may be predicted, and two tasks may be learned in a multi-task manner to reflect information on physical properties/defects in the latent space. According to another example, a method of separating and learning a geometric latent space that is invariant to physical properties/defects may be used. According to another example, a method of performing a learning by reflecting the difference between physical properties/defects in a metric may be used. That is, the operation of updating clustering by reflecting similar physical properties/defects concept may be based on various methods that may reflect, onto the latent space, the result of physical properties/defects corresponding to the pattern image.

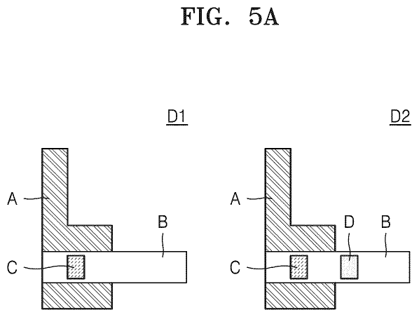

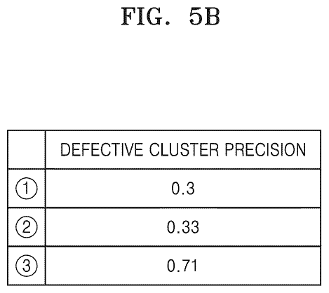

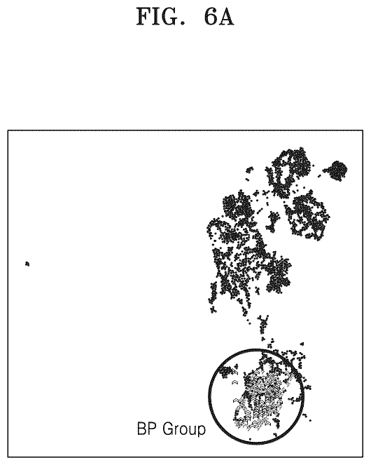

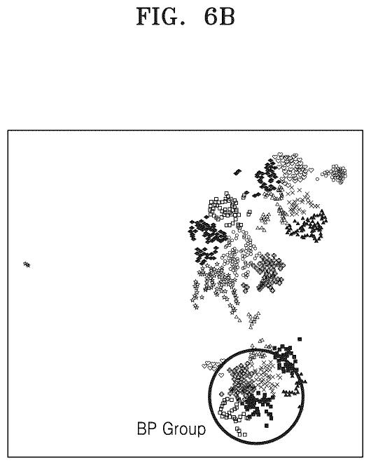

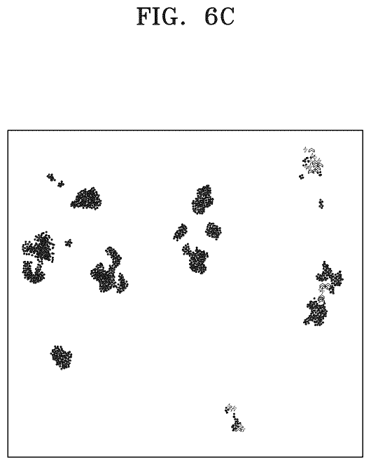

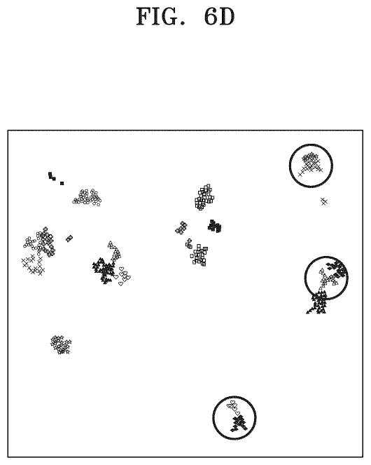

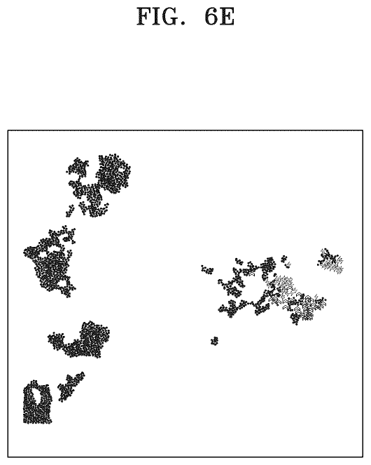

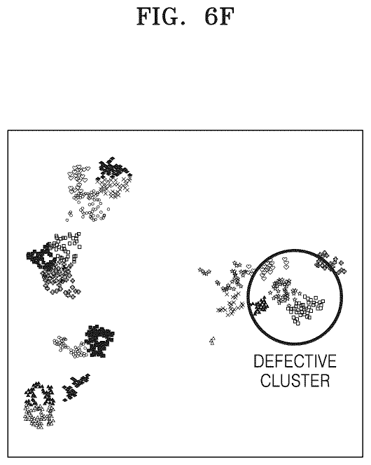

FIG. 5A illustrates comparative layout diagrams, and FIG. 5B is a table illustrating accuracy of a bad cluster according to output at each stage of clustering. FIGS. 6A to 6F are diagrams illustrating an output in each stage of clustering.

The left layout diagram D1 shown in FIG. 5A is an example of a pattern in which a defect occurs, and the right layout diagram D2 shown in FIG. 5A may be an example of a good pattern that has a pattern similar to that causing a defect but does not cause a defect. The left layout diagram D1 of FIG. 5A may be a vulnerable pattern from a stress point of view, and may include an A-B-C pattern. The right layout diagram D2 of FIG. 5A is geometrically similar to the left layout diagram D1, but may include an A-B-C-D pattern that is not defective.

Although the geometric features of the left and right layout diagrams D1 and D2 shown in FIG. 5A are similar, the simulation results resulting from each pattern may be different. When the layout pattern is classified only by geometric features, the left and right layout diagrams D1 and D2 may be included in the same group. However, since the actual simulation results are different, the accuracy of classification may be lowered when a group containing the left and right layout diagrams D1 and D2 is treated as a defective cluster.

According to an example, a latent space in which only geometric features have been learned is illustrated in FIGS. 6A and 6B. Referring to FIG. 6A, an example of a latent space primarily created based on an input pattern image is illustrated. FIG. 6A is an example of a latent space of first clustering formed by pattern reconstruction learning. Each point of FIG. 6A may correspond to one pattern, and it may mean that the closer the two points are, the more geometrically similar the patterns. Referring to FIG. 6A, it may be seen that a plurality of defective patterns are observed in a local space among clusters formed by gathering a plurality of points. According to an example, such a defective pattern may be a pattern-induced defect. In FIG. 6A, a pattern represented by a shape other a dot may be a defective pattern (represented by a chevron) or a normal pattern (represented by a lightning shape) having a shape similar to that of the defective pattern. According to an example, a defective pattern and normal patterns having a shape similar to the defective pattern may gather to form a defective cluster group (i.e., a bad pattern (BP) group).

Referring to FIG. 6B, an example of a latent space in which clustering is performed based on FIG. 6A is shown. Referring to FIG. 6B, points having the same shape may be interpreted as one cluster. In the case of a defective cluster (BP Group), it means a cluster with many defects, and the commonality of the clusters may be the cause of the defect.

Referring to FIGS. 6A and 6B, it is confirmed that the defective pattern is concentrated in a specific cluster. However, like the right layout diagram D2 in FIG. 5A, the A-B-C-D pattern that is geometrically similar to the defect but not the defect is classified into the same cluster, and interpreting the cluster as a defective cluster causes a problem that the defect accuracy is low, e.g., 0.3. Referring to the table of FIG. 5B, the accuracy of the defective cluster corresponding to a first result \textcircled{1} is described as 0.3. The first result may mean a result of performing clustering through only geometric features corresponding to FIGS. 6A and 6B.

To improve this, additional learning may be done to follow a Gaussian mixture model. The resulting latent space and clustering results may correspond to FIGS. 6C and 6D, and the accuracy of the resulting defective cluster corresponds to a second result \textcircled{2} of FIG. 5B.

FIG. 6C is an example of a latent space trained by additionally applying Gaussian mixture model learning. Referring to FIG. 6C, as compared with the case of FIG. 6A, each cluster may be formed to be spaced apart from each other, and it may be seen that a latent space suitable for clustering is being trained.

Referring to FIG. 6D, an example of a latent space in which clustering is performed based on FIG. 6C is shown. Referring to FIG. 6D, as compared with FIG. 6B, it may be seen that patterns that were included in a defective cluster are formed to be spaced apart from each other in various clusters. Referring to the table of FIG. 5B, the accuracy of the defective cluster corresponding to the second result \textcircled{2} is described as 0.33. The second result \textcircled{2} may mean a result of performing clustering by additionally applying Gaussian mixture model learning corresponding to FIGS. 6C and 6D.

To further improve this, the latent space and the clustering result obtained by learning the defect inspection result through the pairwise constraint may be shown through FIGS. 6E and 6F, and the accuracy of the defective cluster according to this may correspond to the result of a third result \textcircled{3} of FIG. 5B.

Referring to FIG. 6E, an example of a latent space formed by inspection reflection learning is shown. Referring to FIG. 6E, as compared with FIG. 6A, it may be seen that a good pattern (of a lightning shape) that has been classified as a defective cluster is separated. The chevron indicates a defective pattern, and the lightning shape indicates a good pattern similar to the defective pattern. According to an example, the lightning shape may correspond to the right layout diagram D2 of FIG. 5A, and the chevron may correspond to the left layout diagram D1 of FIG. 5A. In the defective cluster (BP Group) of FIG. 6A, the lightning shape and the chevron shape are not distinguished from each other and are formed as one cluster, but in the cluster formed by feeding back the simulation result according to FIG. 6E, the lightning shape and the chevron shape are separated into different clusters.

Referring to FIG. 6F, an example of a latent space in which clustering is performed based on FIG. 6E is shown. Referring to FIG. 6F, groups including only defective clusters may be easily identified compared to examples of FIGS. 6B and 6D. Referring to the table of FIG. 5B, the accuracy of the defective cluster corresponding to the third result \textcircled{3} is described as 0.71. The third result \textcircled{3} may mean a result of performing clustering by additionally applying the pairwise constraint learning corresponding to FIGS. 6E and 6F. Pairwise constraint learning is given as a positive number if both patterns are bad or good at the same time, is given as a negative number if one is defective and the other is good, and is given as zero if the inspection result of even one is not known. Accordingly, it is confirmed that the A-B-C pattern is classified as a vulnerable pattern, and the accuracy has increased to 0.71. That is, it is confirmed that the clustering method may be used to analyze an actual semiconductor design defect.

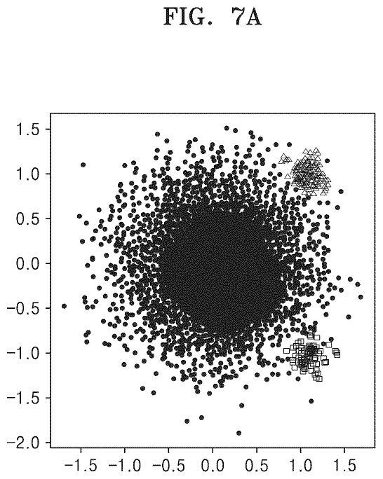

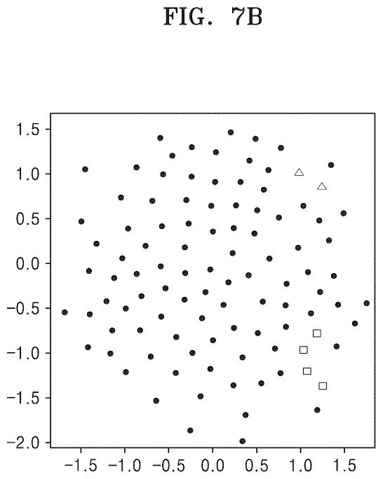

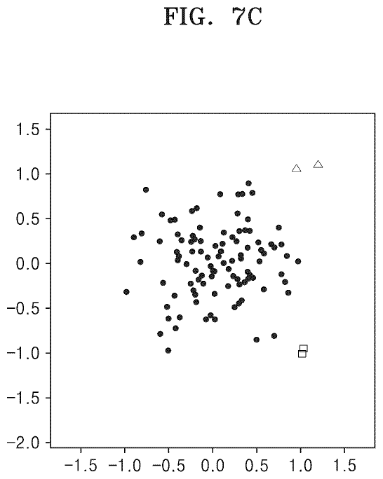

FIG. 7A is a diagram illustrating a distribution of latent space, FIG. 7B is a diagram illustrating data sampling, and FIG. 7C is a diagram illustrating data sampling as a comparative example.

Referring to FIG. 7A, a latent space illustrating a result of first or M-th completion of clustering is illustrated. In this case, M may be a natural number greater than or equal to 2. The latent variables distributed in the latent space of FIG. 7A follow a Gaussian mixture model, and the latent variables reflecting the simulation result may be clustered.

FIG. 7B illustrates a diagram for explaining a method of sampling data to be additionally simulated among latent variables in the latent space of FIG. 7A. FIG. 7C is a diagram for explaining data sampling according to a comparative example.

In FIGS. 7A to 7C, patterns included in the same group are shown as the same shape, and patterns included in different groups are shown as different shapes.

Referring to FIG. 7A, the majority of the shapes are distributed as circular shapes, and the triangular shape and the square shape are included in a significantly lower number than the circular shape. This corresponds to a case in which the majority of clusters corresponding to the circular shape are present. In the case that the number of any cluster is the majority, as described above, when a sample to be simulated is randomly selected as shown in FIG. 7C, most of the samples are selected in a circular shape, and most of the samples may be selected in a similar pattern. In this case, even if the simulation is performed, only a simulation in a similar pattern in the same group is performed, and thus the inspection of various patterns may be difficult.

The sampling operation according to some implementations of the present disclosure may include an operation of securing pattern diversity and resolving data imbalance. In terms of securing pattern diversity, since it is challenging to simulate or measure all possible patterns, it may be useful to select a limited number of patterns to represent the data. Resolution of data imbalances may be useful because data imbalances may interfere with clustering or other analysis processes when there are multiple similar patterns in a dataset. To achieve this, various sampling techniques may be used, and the system stability may be improved by improving the performance of the model with the representativeness and balance of the obtained data.

In some implementations, data is sampled so that results of various patterns may be obtained as shown in FIG. 7B. Referring to FIG. 7B, a sampling methodology for obtaining results of various patterns in limited simulation/inspection is disclosed. According to an example, a methodology of selecting a pattern by K-center sampling in a latent space may be used. According to another example, data sampling may be performed based on importance sampling, Markov chain Monte Carlo, Latin hypercube sampling, adaptive sampling, covering ensemble, and/or the like. According to an example, data sampling for obtaining results of various patterns in limited simulation may be performed. According to an example, in the latent space, an independent sample may be extracted in terms of the latent space and distance by applying a methodology for selecting various patterns. According to an example, diversity may be obtained by selecting samples far from each other in a latent space. According to an example, such selection of simulation data may be performed by the clustering analyzer 12 of FIG. 1.

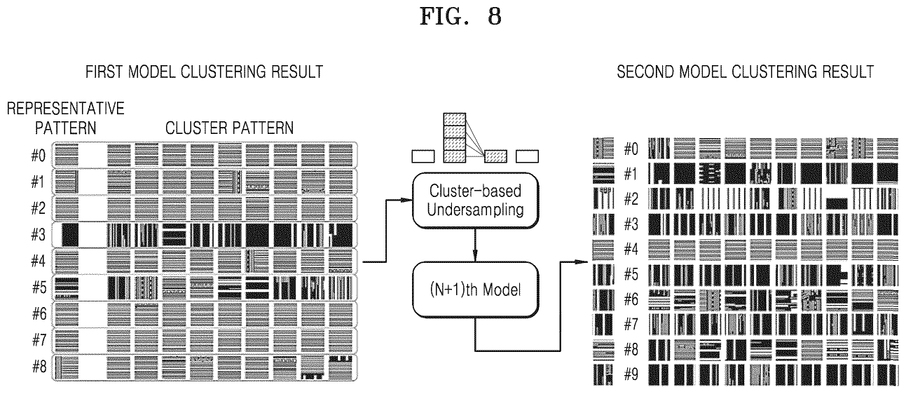

FIG. 8 is a diagram illustrating balanced sampling according to an example.

Referring to a first model clustering result of FIG. 8, pattern images included in each of a plurality of clusters, and representative patterns representing the same, are shown.

According to the first model clustering result of FIG. 8, horizontal stripe patterns compose more than 50% of representative patterns among a plurality of clustered patterns, and a case in which most clusters are composed of only a plurality of patterns is illustrated. In this case, since clustering is concentrated only on the horizontal stripe pattern, additional sampling may be used to solve this problem and achieve diversity. According to an example, when a plurality of patterns are similar and thus the performance of learning and clustering is deteriorated, data may be sampled by correcting the imbalance of the pattern by undersampling. When the data subjected to undersampling using cluster information is used for the next training, a cluster with improved diversity may be obtained.

Accordingly, referring to the secondary model clustering result, which is the result of performing (N+1)th modeling, it may be seen that the existing overlapping horizontal stripe pattern clustering is eliminated and relatively more diverse representative patterns are formed.

According to an example, when the similarity of the extracted representative patterns is more than half after M-th clustering is completed, (M+1)th clustering that secures more diversity may be secured by performing undersampling on the corresponding patterns. Although undersampling is used as an example in FIG. 8, other correction methods are within the scope of this disclosure. For example, data imbalance occurring when a plurality of similar patterns exist may be corrected based on balanced sampling. The balanced sampling may mean a technique for sampling data to solve a data imbalance problem by matching a ratio of minority classes with respect to majority classes. Examples of balanced sampling within the scope of this disclosure include undersampling, oversampling, and synthetic minority oversampling techniques (SMOTE).

The sampling operation in FIGS. 7B and 8 according to an example may be a data sampling methodology for improving performance. According to an example, such a simulation data selection and sampling operation may be performed by the clustering analyzer 12 of FIG. 1.

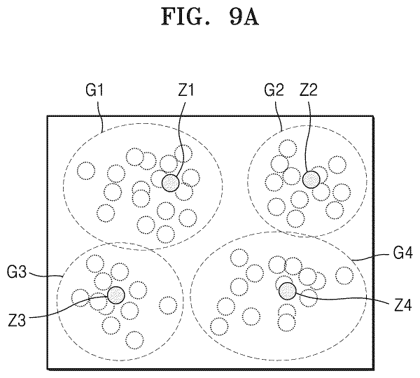

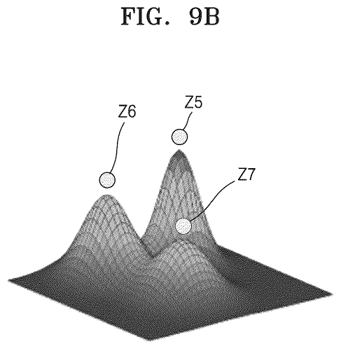

FIGS. 9A and 9B are diagrams illustrating a method of selecting a representative pattern.

Through the previous clustering learning result, final pattern clustering may be output. The final pattern clustering follows a Gaussian mixture model in the latent space, may be clustered based on the geometric features of the pattern image and the simulation results, and may be the result of improving the imbalance of the data. Accordingly, the final pattern clustering may include a plurality of clusters, and a representative pattern in each cluster may be selected.

Referring to FIG. 9A, distance-based pattern selection may be performed. According to an example, the distance-based pattern selection may select a pattern based on a distance between latent variables distributed in a latent space. According to an example, a pattern closest to the center of a plurality of clusters included in the final pattern clustering may be selected as a representative pattern. Referring to FIG. 9A, a representative pattern of the first group G1 may be selected as the first pattern Z1, a representative pattern of the second group G2 may be selected as the second pattern Z2, a representative pattern of the third group G3 may be selected as the third pattern Z3, and a representative pattern of the fourth group G4 may be selected as the fourth pattern Z4.

Referring to FIG. 9B, probability-based pattern selection may be performed. According to an example, the probability-based pattern selection may select a pattern with the highest probability in each mode of the Gaussian mixture model calculated by a model, e.g., a pattern closest to the center of each mode. Referring to FIG. 9B, patterns Z5, Z6, and Z7 having the highest density among Gaussian mixture model may be selected as representative patterns.

The method of selecting the representative pattern according to FIGS. 9A to 9B is only an example, and the representative pattern may be selected according to another algorithm.

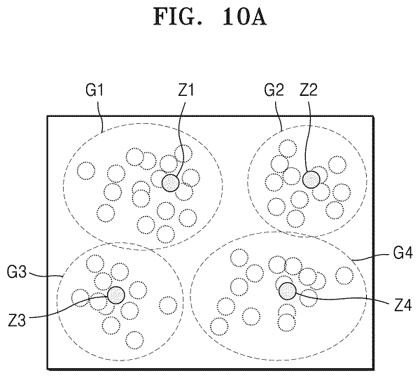

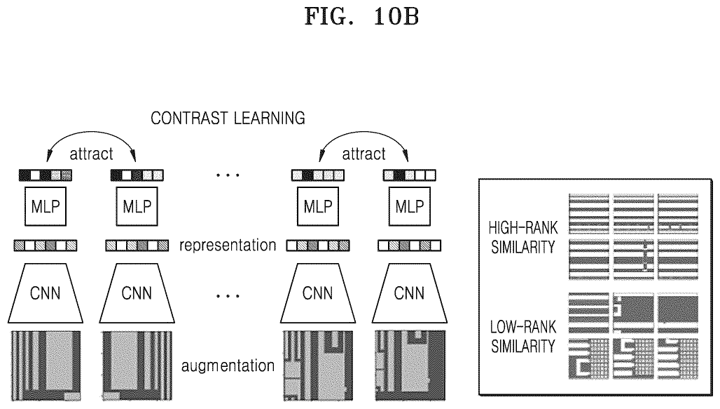

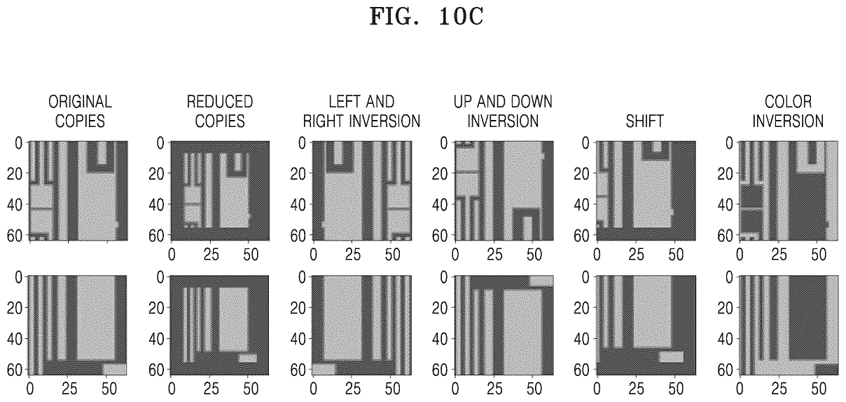

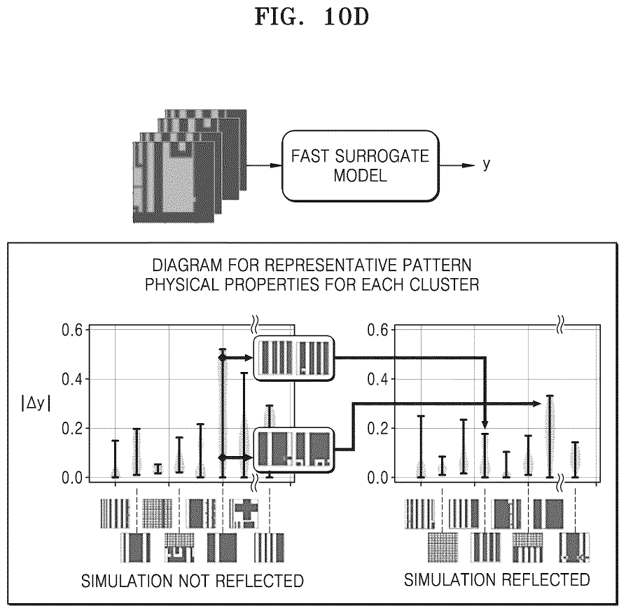

FIGS. 10A to 10D are diagrams illustrating methods of evaluating performance of a representative pattern.

In FIG. 10A, an example of evaluating based on a distance is disclosed in order to evaluate the performance of a representative pattern. Distance-based evaluation may be an index that measures how close the representative pattern in the latent space is to the pattern within the cluster and how far the representative pattern in the latent space is from the pattern outside the cluster. The distance-based evaluation may be used by replacing the center with the position of the representative pattern in a general cluster evaluation methodology.

The distance-based evaluation of the representative pattern may be evaluated by the following equations.

$$score = \frac{1}{k} {\sum }_{i = 1}^{k} {r}_{i}$$

$${r}_{i} = {max}_{i \neq j} {R}_{i j} ; {R}_{i j} = \frac{{s}_{i} + {s}_{j}}{{d}_{i j}}$$

In the equations, Si means an average distance within a cluster to the representative pattern, that is, an average distance between data belonging to a cluster and a cluster center, and dᵢⱼ means a distance between representative patterns. These are equations according to the Davies-Bouldin index. According to an example, the distance-based evaluation of FIG. 10A may be processed based on coordinate information in a latent space.

According to an example, it is assumed that a distance-based evaluation of the first representative pattern Z1 included in the first group G1 and the second representative pattern Z2 included in the second group G2 is performed. R₁₂ may be calculated by dividing the value obtained by adding the average distance s₁ in the cluster of the first representative pattern Z1 in the first group G1 and the average distance s₂ in the cluster of the second representative pattern Z2 in the second group G2 by the distance d₁₂ between the first representative pattern Z1 and the second representative pattern Z2. j in which R₁₂ is maximized for the i=1 value will be dᵢⱼ with the shortest distance between cluster centers, and the average for all clusters is a score value. It may be determined that the lower the score value, the better the cluster, and it may be seen that the representative pattern may be appropriately selected.

FIGS. 10B and 10C are diagrams to describe a method of evaluating similarity between pattern images. According to an example, the geometric similarity evaluation may quantitatively compare the degree to which the representative pattern is geometrically similar to other patterns in the cluster by calculating the similarity based on the layout pattern-oriented contrast learning model. Contrast learning is a method of learning data such that pairs of similar data are trained to be close to each other and pairs of dissimilar data are trained to be far from each other. The similarity between the pairs of data may be measured by learning that the pairs of transforming data itself are trained to be close to each other and the other pairs of data are trained to be far from each other, based on the idea that there is a feature of the data that is not changed in the data transform. According to an example, as shown in FIG. 10C, contrast learning may be performed using conversion images such as original copies, reduced copies, left and right inversion, up and down inversion, partial shift, and color inversion of the pattern images. According to an example, a crop image that deletes a part of a pattern when transforming a pattern image for contrast learning may not be used for contrast learning because the crop image is a transformation that differs in important features such as circuit connectivity or density.

According to an example, it may be determined whether the representative pattern is a pattern similar to other patterns in the cluster through the contrast learning model, and when the determined value satisfies a criterion, it may be determined that the representative pattern is appropriately selected.

Looking at the samples of the upper-rank/lower-rank two clusters shown in FIG. 10B, it may be seen that the samples of clusters evaluated with high similarity have similar patterns, and the samples of clusters evaluated with low similarity have relatively different patterns. According to an example, the similarity-based evaluation of FIGS. 10B and 10C does not require coordinate information in a latent space and may be processed based on a label of a pattern image.

Contrast learning has been described as a method of evaluating the similarity between pattern images, but a method other than contrast learning may be used as a method of evaluating the similarity between pattern images. According to another example, similarity between pattern images may be evaluated based on shape-based similarity (e.g., contour matching or shape context) or structural similarity index (SSIM), and a method of measuring similarity by using a pre-training model as a feature extractor may be used by applying a deep learning-based methodology.

FIG. 10D illustrates an example of evaluating representative performance in terms of physical properties/defects. According to an example, in a pattern group including a representative pattern, since physical properties and simulation results should be similarly extracted, simulation may be performed for each cluster. According to an example, the similarity evaluation in terms of the physical properties/possibility of defects may evaluate representativeness in terms of physical properties/defects by predicting the simulation/inspection results for each pattern with a surrogate model by using simulation data. The prediction of the simulation/inspection according to an example may be confirmed by visualizing the difference between the representative pattern and other patterns in the cluster. The illustration of FIG. 10D is a result of evaluating the similarity of physical properties in each cluster by utilizing the visualizing of the difference. The violin chart on the right side of the visualized physical property stool chart is the result of clustering and representative pattern selection reflecting the simulation results. The Y-axis of the graph |Δy| is an absolute value of a difference in physical properties between each pattern in the cluster and a representative pattern. In the results reflecting the simulation, it is confirmed that the difference in physical properties within the cluster decreases. According to an example, the representativeness evaluation in terms of physical properties/defects of FIG. 10D may be processed based on information on physical properties in each group.

In FIGS. 10A to 10D, performance of a representative pattern in each cluster may be evaluated using various methods. The method of evaluating the performance of the representative pattern in FIGS. 10A to 10D is an example, and the scope of this disclosure is not limited thereto.

According to an example, the performance evaluation method of each representative pattern may be independent, and when any one of the performance evaluation results is satisfied, it may be determined that the representative pattern is appropriately selected.

The method of selecting the representative pattern of FIGS. 9A and 9B and the evaluation of the representative pattern of FIGS. 10A to 10D according to an example may be performed by the representative pattern generator 13 of FIG. 1.

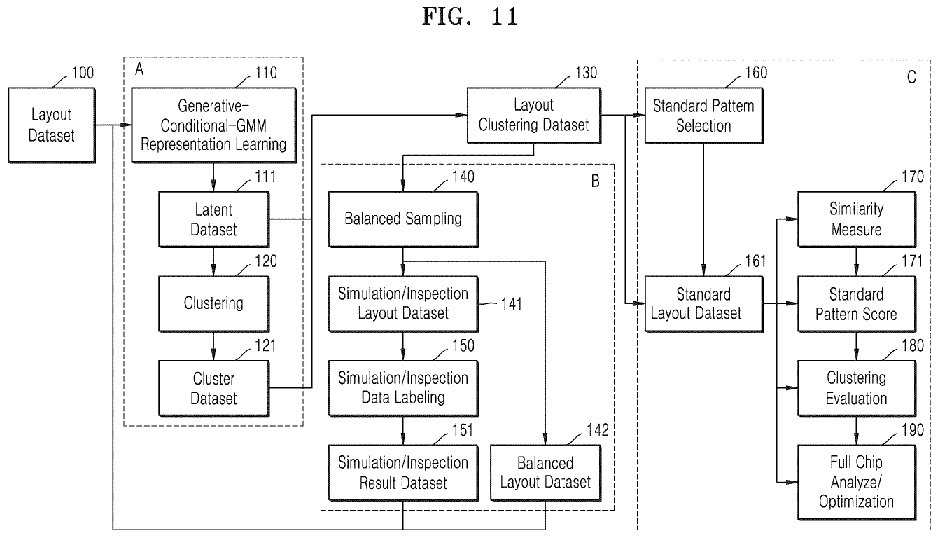

FIG. 11 is a block diagram illustrating operations of pattern clustering. According to some implementations of the pattern clustering described herein, the design of the entire circuit may be systematically verified by a methodology for classifying layout patterns and selecting representative patterns by simultaneously interpreting, or incorporating, geometric features, physical properties/defects, and clustering. As such, this disclosure provide models capable of learning not only the geometric similarity of the pattern but also the similarity of the simulation/inspection results as latent variables. In addition, latent variables may be designed to be suitable for clustering, and a balanced methodology for stability in learning is provided.

A purpose of pattern clustering as described herein may be to classify similar patterns in terms of physical properties/defect possibilities, and to select a pattern representing the classified cluster. The selection of the representative pattern may be useful when analyzing the entire circuit design in a divide and conquer rule. According to an example, in an example of analyzing the warpage of the entire circuit, a stress map of the entire circuit may be required in a comparative example in which the methods described herein are not used, but a complete enumeration method of calculating the stress of all patterns and mapping the calculated stress to the entire circuit may not be feasible. Therefore, as described herein, a set of patterns capable of representing the entire pattern may be selected, and the stress may be calculated and mapped. Selecting a pattern set having high representativeness from the viewpoint of physical properties/possibilities of defects is useful for analysis, and this disclosure provides structured methodologies for doing this.

Referring to FIG. 11, a block diagram of pattern clustering is divided into three regions A, B, and C.

In the region A, pattern features may be trained and clustered. That is, in the region A, the model for extracting the pattern feature may be trained and the pattern may be clustered. Latent variables reflecting relevant pattern features may be learned.

In the region B, the simulation/inspection pattern may be selected and analyzed. According to an example, simulation/inspection may be performed by selecting a pattern to improve a learning model. The result may be repeatedly fed back to the region A to improve the learning model, so that pattern features (or latent variables reflecting those pattern features) that reflect the physical properties and/or possibility of defects of the patterns are learned.

In the region C, the representative pattern may be selected and evaluated. According to an example, the clustering may be analyzed by analyzing the pattern features extracted by the learning model, selecting and evaluating a representative pattern, and the entire circuit may be analyzed and optimized based thereon. A detailed data flow of each region is described in detail below.

According to an example, the entire integrated circuit may be divided into unit patterns having the size of a verification window to then be stored as a layout dataset 100, which may be input data of a block 110 of the region A. According to an example, the layout dataset 100 may be a pattern image.

The block 110 in the region A may perform an operation of learning a model that extracts a feature of a pattern. According to an example, generative learning may include an operation of converting input data into a low-dimensional latent variable and then restoring the input data again. The low-dimensional latent space of the data represented by the trained model is utilized (e.g., mainly utilized) to identify the similarity or rules of the data and may also be utilized for tasks such as data visualization or clustering. The learning in the block 110 in the region A may be an operation of performing learning capable of reflecting the simulation and the inspection result to simultaneously interpret the geometric feature and the physical property/defect possibility in the corresponding latent space. Furthermore, the model is designed to be suitable for clustering, thereby operating in an end-to-end manner without any other procedure from latent variable extraction to clustering, allowing for efficient analysis of vast amounts of data in the entire circuit. According to one example, post-processing is not required after training, and the cluster may be extracted immediately through training of the corresponding model, which is efficient.

For example, the method of learning features for pattern clustering may express the geometric features of the pattern as low-dimensional latent variables through learning to convert high-dimensional images into low-dimensional latent variables and restore the high-dimensional images again. Furthermore, the distribution of latent variables may be trained to follow the Gaussian mixture model. In addition, by learning the simulation/inspection results with pairwise constraints, latent variables reflecting the features of important patterns in physical properties/defects may be obtained. According to an example, block 111 is an output of block 110 and may mean information in a latent space such as a latent variable of a pattern or a cluster probability. The cluster probability is the probability that the pattern belongs to each mode in the learned Gaussian mixture model. According to an example, the block 110 may be an operation of setting a dataset of latent variables based on latent space information, and a block 120 may be an operation of performing clustering according to a learning result. The clustering in the block 120 according to an example may perform probability-based clustering. The probability-based clustering is the interpretation of a mode with the highest probability in the Gaussian mixture model as a cluster of patterns. The probability-based clustering may be operated in an end-to-end manner, enabling relatively fast analysis. A block 121 may be an operation of performing labeling on a plurality of clusters. The block 121 may represent information on clusters of each pattern, and may constitute a block 130 in combination with the block 111.

Learning of blocks 110 to 121 according to an example may be completed while improving the learning model by repeatedly receiving feedback on the result of a block 151 which is a simulation/inspection result. According to an example, the first model without simulation/inspection results may be trained in a state in which both pairwise constraint indices are 0.

The block 130 according to an example may be in a state in which a plurality of clusters for which a representative pattern is not selected are labeled. When the corresponding operation is an operation in which final clustering is completed, the next operation may proceed to a block 160, and when the corresponding operation is an operation in which final clustering is not completed, the next operation may proceed to a block 140.

According to an example, the block 140 in the region B may be a data sampling methodology for improving the performance of the learning model. A block 141 may include a sampling methodology for obtaining results of various patterns in limited simulation/inspection. According to an example, a methodology of selecting a target pattern by K-center sampling in a latent space may be included. When a plurality of patterns are similar and the performance of learning and clustering is deteriorated, a block 142 may mean sampled data obtained by correcting the imbalance of the pattern through balanced sampling. According to an example, blocks 150 and 151 may be calculated by simulating and inspecting the pattern selected by the block 140. A block 150 may be data labeled with simulated and inspected data, and a block 151 defines the data labeled in the block 150 as pairwise constraints and performs secondary learning to create a secondary model. The completed model by repeatedly performing this process may form a latent space for simultaneously interpreting the geometric features, physical properties/defects, and clustering of patterns.

Referring to a block 160, a representative pattern may be extracted from clustering finally formed through the previous processes. A block 161 is configured by grouping the selected representative pattern and data of the block 130. These data may be input to a block 170 and used to evaluate representativeness of the representative pattern. In a block 170, distance-based evaluation, geometric similarity evaluation, and physical/defect possibility similarity evaluation are performed.

A block 171, which is a quantitative evaluation value calculated according to an example, may be input to a block 180 together with the output from the block 161. A block 180 may be an operation of determining whether it is appropriate to analyze the entire circuit by clustering and representative patterns. In this process, visualizations of defective clusters, representative pattern charts, and stool charts may be used. A block 190 may be an entire circuit analysis operation. According to an example, by analyzing a layout pattern of a portion where defects are concentrated in a latent space, factors causing defects may be discovered, and design may be optimized by analyzing a defect margin. In addition, the design may be optimized by transferring representative patterns having high representativeness to the entire circuit, enabling full circuit analysis such as hotspot detection or full-chip simulation. As such, the performance of the integrated circuit as a whole (e.g., fabrication/defect performance, operation performance, electrical performance, performance in simulations, and/or the like) can be evaluated based on the representative patterns.

As such, extended techniques capable of identifying and classifying significant geometric features from simulation and inspection results by including simulation/inspection operations in a series of processes of classifying layout patterns are described. In addition, this disclosure provides sampling methodologies to improve the performance of the provided technology (e.g., the technology of integrated circuit design and evaluation) and a methodology to systematically and quantitatively select and evaluate representative patterns for overall circuit simulation, when selecting the representative patterns for overall circuit simulation. According to an example, the concepts described herein may be applied to pattern classification of all types of semiconductor layout patterns, and may be applied to pattern classification that may perform patterning simulation and emulation, and thus label semiconductor features and defects.

FIG. 12 is a block diagram illustrating a computer system 1300. In some implementations, the computer system 1300 of FIG. 12 performs training of the machine learning models used for pattern clustering described above with reference to the drawings, and may be referred to as a pattern clustering system, a training system, or the like.

The computer system 1300 may refer to any system including a general purpose or special purpose computing system. For example, the computer system 1300 may include a personal computer, a server computer, a laptop computer, a home appliance, and the like. As shown in FIG. 12, the computer system 1300 may include at least one processor 1310, a memory 1320, a storage system 1330, a network adapter 1340, an input/output (I/O) interface 1350, and a display 1360.

The at least one processor 1310 may execute a program module including computer system executable instructions. The program module may include routines, programs, objects, components, logic, data structures, and the like, performing a specific task or implementing a specific abstract data type. The memory 1320 may include a computer system readable medium in the form of a volatile memory such as a random access memory (RAM). The at least one processor 1310 may access the memory 1320 and execute instructions loaded in the memory 1320. The storage system 1330 may non-volatilely store information and may include at least one program product including a program module configured to perform training of the machine learning models for pattern clustering described above with reference to the drawings. A program may include, by way of non-limiting examples, an operating system, at least one application, other program modules, and program data.

The network adapter 1340 may provide a connection to a local area network (LAN), a wide area network (WAN), and/or a public network (e.g., the Internet), etc. The I/O interface 1350 may provide a communication channel with a peripheral device such as a keyboard, a pointing device, and an audio system. The display 1360 may output various pieces of information so that the user may check the information.

In some implementations, the training of the machine learning models for pattern clustering described above with reference to the drawings is implemented as a computer program product. The computer program product may include a non-transitory computer-readable medium (or storage medium) including computer-readable program instructions for causing the at least one processor 1310 to perform image processing and/or training of models. Computer readable instructions may be, but are not limited to, assembler instructions, instruction set architecture (ISA) instructions, machine instructions, machine dependent instructions, microcode, firmware instructions, state setup data, or source code or object code written in at least one programming language.

The computer-readable medium may be any type of medium capable of non-transitorily holding and storing instructions executed by the at least one processor 1310 or any instruction executable device. The computer-readable medium may be an electronic storage device, a magnetic storage device, an optical storage device, an electromagnetic storage device, a semiconductor storage device, or any combination thereof, but is not limited thereto. For example, the computer readable medium may be a portable computer diskette, a hard disk, a random access memory (RAM), a read-only memory (ROM), an electrically erasable read only memory (EEPROM), a flash memory, a static random access memory (SRAM), a compact disc (CD), a digital versatile disc (DVD), a memory stick, a floppy disk, a mechanically encoded device such as a punch card, or any combination thereof.

FIG. 13 illustrates a system 1400. In some implementations, pattern clustering as described herein may be executed in or by the system 1400.

Referring to FIG. 13, the system 1400 may include at least one processor 1410, a memory 1430, an artificial intelligence (AI) accelerator 1450, and a hardware (HW) accelerator 1470, and the at least one processor 1410, the memory 1430, the AI accelerator 1450, and the HW accelerator 1470 may communicate with each other through a bus 1490. In some implementations, the at least one processor 1410, the memory 1430, the AI accelerator 1450, and the HW accelerator 1470 are included in one semiconductor chip. Furthermore, in some implementations, at least two of the at least one processor 1410, the memory 1430, the AI accelerator 1450, and the HW accelerator 1470 are included in two or more semiconductor chips mounted on a board, respectively.

The at least one processor 1410 may execute instructions. For example, the at least one processor 1410 may execute an operating system by executing instructions stored in the memory 1430, or may execute applications executed on the operating system. In some implementations, at least one processor 1410 instructs the AI accelerator 1450 and/or the HW accelerator 1470 to perform a task by executing instructions, and may obtain a result of performing the task from the AI accelerator 1450 and/or the HW accelerator 1470. In some implementations, the at least one processor 1410 is an application specific instruction set processor (ASIP) customized for a specific purpose, and may also support a dedicated instruction set.

The memory 1430 may have an arbitrary structure for storing data. For example, the memory 1430 may include a volatile memory device such as a dynamic random access memory (DRAM) or a static random access memory (SRAM), or a non-volatile memory device such as a flash memory or a resistive random access memory (RRAM). The at least one processor 1410, the AI accelerator 1450, and the HW accelerator 1470 may store data in the memory 1430 or read data from the memory 1430 through the bus 1490.

The AI accelerator 1450 may refer to hardware designed for AI applications. In some implementations, the AI accelerator 1450 includes a neural processing unit (NPU) for implementing a neuromorphic structure, may generate output data by processing input data provided from the at least one processor 1410 and/or the HW accelerator 1470, and may provide the output data to the at least one processor 1410 and/or the HW accelerator 1470. In some implementations, the AI accelerator 1450 is programmable and may be programmed by the at least one processor 1410 and/or the HW accelerator 1470.

The HW accelerator 1470 may refer to hardware designed to perform a specific task at high speed. For example, the HW accelerator 1470 may be designed to perform data transformation such as demodulation, modulation, encoding, and decoding at high speed. The HW accelerator 1470 may be programmable and may be programmed by the at least one processor 1410 and/or the HW accelerator 1470.

In some implementations, the AI accelerator 1450 may execute the machine learning models described above with reference to the drawings. For example, the AI accelerator 1450 may execute some or all of the learning tasks described above. The AI accelerator 1450 may generate an output including useful information by processing input parameters, feature maps, and the like. In addition, at least some of the models executed by the AI accelerator 1450 may be executed by the at least one processor 1410 and/or the HW accelerator 1470.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While examples have been shown and described, it will be understood that various changes in form and details may be made therein without departing from the spirit and scope of the present disclosure.

What is claimed is:

1. A method of evaluating an integrated circuit, the method comprising:
obtaining a plurality of patterns representing a layout of the integrated circuit;
clustering the plurality of patterns into a plurality of clusters based on geometric features of the plurality of patterns, and
simulation results obtained by simulating properties of the plurality of patterns;
selecting a representative pattern of each of at least one cluster of the plurality of clusters; and
verifying the representative pattern of each of at least one cluster and evaluating performance of the integrated circuit based on this.

2. The method of claim 1, wherein clustering the plurality of patterns comprises clustering in a latent space by representing the plurality of patterns and the simulation results as latent variables.

3. The method of claim 1, wherein clustering the plurality of patterns is performed based on a Gaussian mixture model.

4. The method of claim 1, wherein clustering the plurality of patterns comprises:
obtaining a first clustering result based on the geometric features, and
modifying the first clustering result to obtain a second clustering result by a feedback process based on the simulation results using a pairwise constraint.

5. The method of claim 1, wherein clustering the plurality of patterns comprises performing data sampling such that an imbalance in similarities of the plurality of patterns is compensated for.

6. The method of claim 5, wherein performing the data sampling comprises at least one of:
applying balanced sampling to the plurality of patterns, or
selecting a pattern of the plurality of patterns to be simulated to compensate for the imbalance.

7. The method of claim 1, wherein selecting the representative pattern of each of the at least one cluster comprises selecting the representative pattern based on a distance, in a space in which the plurality of patterns are clustered, between a representation of the representative pattern and a representation of at least one other pattern of the plurality of patterns.

8. The method of claim 1, wherein selecting the representative pattern of each of the at least one cluster comprises selecting the representative pattern based on probabilities of the plurality of patterns.

9. The method of claim 1, wherein the verifying the representative pattern of each of the at least one cluster based on a distance measure of the representative pattern in a latent space in which the plurality of patterns are clustered.

10. The method of claim 1, wherein the verifying the representative pattern of each of the at least one cluster based on a similarity between geometric features of the representative pattern and geometric features of at least one other pattern of the plurality of patterns.

11. The method of claim 1, wherein the verifying the representative pattern of each of the at least one cluster based on a similarity between a simulation result of the representative pattern and a simulation result of at least one other pattern in a cluster including the representative pattern.

12. The method of claim 1, wherein evaluating the performance of the integrated circuit comprises performing a simulation of the integrated circuit based on the representative pattern of each of the at least one cluster.

13. A method of simulating an integrated circuit, the method comprising:
performing first clustering, in a latent space, of a plurality of pattern images of layout patterns of the integrated circuit;
updating the first clustering by performing a feedback process on clustering results at least once, to obtain an N-th clustering corresponding to a plurality of clusters;
selecting a representative pattern of each of at least one cluster of the plurality of clusters; and
performing a simulation of the integrated circuit based on the representative pattern of each of the at least one cluster.

14. The method of claim 13, wherein:
the first clustering is performed based on geometric patterns of the plurality of pattern images, and
updating the first clustering comprises updating the first clustering based on results of simulating the plurality of pattern images.

15. The method of claim 13, wherein updating the first clustering comprises updating the first clustering based on a Gaussian mixture model.

16. The method of claim 13, wherein updating the first clustering comprises:
determining that representative patterns of clusters of a result of M-th clustering satisfy a diversity condition, where M is a natural number less than N; and
based on determining that the representative patterns of the clusters of the result of the M-th clustering satisfy the diversity condition, performing sampling to increase pattern diversity.

17. The method of claim 16, wherein the determining that the representative patterns of the clusters of the result of the M-th clustering satisfy the diversity condition comprises determining that a proportion of the representative patterns of the clusters of the result of the M-th clustering having a similar image is greater than a predetermined threshold, and
wherein performing the sampling comprises balance-sampling clusters having representative patterns having the similar image.

18. The method of claim 13, wherein selecting the representative pattern of each of the at least one cluster of the plurality of clusters is based on a distance in the latent space, or probabilities of the plurality of pattern images.

19. A system comprising:
at least one processor; and
a non-transitory storage medium storing instructions that, when executed by the at least one processor, cause the at least one processor to perform operations comprising:
obtaining a plurality of patterns representing a layout of an integrated circuit;
clustering the plurality of patterns into a plurality of clusters based on geometric features of the plurality of patterns, and
simulation results obtained by simulating properties of the plurality of patterns;
selecting a representative pattern of each of at least one cluster of the plurality of clusters; and
verifying the representative pattern of each of at least one cluster and evaluating performance of the integrated circuit based on this.

20. The system of claim 19, wherein clustering the plurality of patterns comprises performing the clustering in a latent space by converting the plurality of patterns and the simulation results into latent variables based on a Gaussian mixture model.
